(19) United States
(12) Patent Application Publication
(10) Pub. No.: US 2005/0127646 A1
(43) Pub. Date: Jun. 16, 2005

(54) Airbag system

(75) Inventor: Rie Kobayashi, Echi-gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 10/998,575

(22) Filed: Nov. 30, 2004

Related U.S. Application Data
(60) Provisional application No. 60/526,077, filed on Dec. 2, 2003.

(51) Int. Cl. B60R 21/22

(52) U.S. Cl. 280/730.2

(57) ABSTRACT

An airbag system for a vehicle having a saddle type seat and a steering mechanism. The airbag system may include a front airbag configured to deploy in front of the vehicle, a side airbag configured to deploy along a side of the vehicle; and a driver airbag configured to deploy between a driver of the vehicle and the steering mechanism.

This application claims the benefit or Provisional Application No. 60/526,077, filed Dec. 2, 2003

### BACKGROUND OF THE INVENTION

The present invention pertains to airbag systems for saddle seat type vehicles, such as watercraft and snowmobiles.

Conventional airbag systems are employed in vehicles such as automobiles. Such conventional airbag systems are configured to protect the driver and passenger(s) in the event of a collision. Other conventional airbag systems may protect the driver or passenger of a motorcycle. Typically, conventional airbag systems for saddle type vehicles, such as JP 2001-219885 (incorporated herein by reference in its entirety), have an airbag situated near the driver's torso or head.

Conventional airbag systems are not designed to operate with snowmobiles or water craft having saddle seats, for example a “jet ski.” In particular, conventional airbag systems are not used to protect the operators and passengers of these vehicles in the case of a collision between one of these saddle seat type vehicles with approaching objects or people. Furthermore, these vehicles do not currently have systems that would provide additional protection to the vehicle and its riders in the case of equipment failure or unanticipated environmental conditions such as, for example, high sea states or avalanches. Thus, there remains a need to provide additional protection for these vehicles.

Most conventional airbag systems only protect the occupants on the interior of the vehicle from injury due to impact with the vehicle interior. However, the riders of saddle seat type vehicles, such as snow mobiles and water crafts, are susceptible to injury resulting from contact with an object or other person colliding with the vehicle.

Certain occupant protection systems for saddle vehicles may also include enclosures for driver or passengers of a saddle vehicle such as a motorcycle. Such conventional systems do not use airbags, but rather use enclosures that are continuously in position on the motorcycle, as seen in U.S. Pat. No. 6,017,076 (incorporated herein by reference in its entirety). These conventional systems do not protect the riders or vehicle in the event of a snow-slide or drifting away in water.

### SUMMARY OF THE INVENTION

According to an embodiment of the present invention, for a vehicle having a saddle type seat and a steering mechanism is provided. The airbag system may include a front airbag configured to deploy in front of the vehicle, a first side airbag configured to deploy along a side of the vehicle; and a driver airbag configured to deploy between a driver of the vehicle and the steering mechanism.

According to another embodiment of the present invention an airbag system for a saddle seat type vehicle is provided. The airbag system is configured to detect a proximate object and deploy at least one of a plurality of airbags to protect the vehicle and/or the object from damage resulting from a collision between the object and the vehicle.

According to yet another embodiment of the present invention, an airbag system for a snowmobile is provided. The airbag system includes an airbag that is configured to inflate in the event of a snow slide to protect the snowmobile and its driver.

According to still another embodiment of the present invention, an airbag system for a snowmobile is provided. The system includes a plurality of airbags configured to inflate around the exterior of the snowmobile when a collision between the snowmobile and an object is detected to thereby protect the snowmobile and the object from injury or damage.

According to another embodiment, an airbag system for a water craft having a saddle type seat for an operator of the craft is provided. The system includes a plurality of inflatable bags that are configured to inflate when a controller determines that the craft is in imminent danger of a collision or sinking.

It is to be understood that both the foregoing general description and the following detailed description are exemplary and exemplary only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is top view of an embodiment of an of airbag system for a saddle vehicle according to the present invention.

FIG. 2 is a perspective view of the airbag system for a saddle vehicle of FIG. 1.

FIG. 3 is a top view of another embodiment of the airbag system for a saddle vehicle according to the present invention.

FIG. 4 is a perspective view of the airbag system for a saddle vehicle of FIG. 3.

FIG. 5 is a top view of the airbag system for a saddle vehicle of FIGS. 1 and 3 before the airbags are deployed.

FIG. 6 is a perspective view of the airbag system for a saddle vehicle of FIGS. 1 and 3 before the airbags are deployed.

FIG. 7 is a perspective view of another embodiment of the airbag system for a saddle vehicle according to the present invention.

FIG. 8 is a perspective view of another embodiment of the airbag system for a saddle vehicle according to the present invention.

FIG. 9 is a perspective view of the airbag system for a saddle vehicle of FIGS. 7 and 8 before the airbags are deployed.

### DETAILED DESCRIPTION

Hereinafter, embodiments of the present invention will be described with reference to the attached drawings.

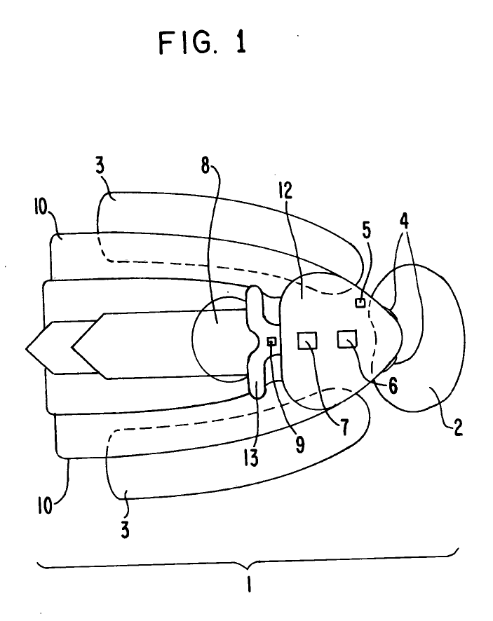

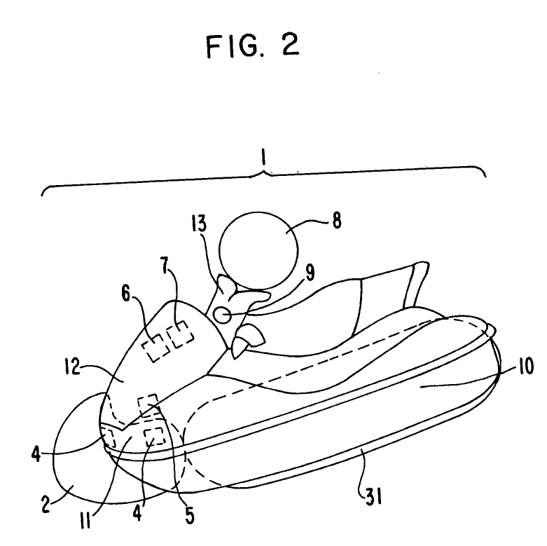

FIGS. 1, 2, 5 and 6 show a watercraft 1 with a saddle type seat. The water craft includes a side portion 10, front portion 11 and a top portion 12. The vehicle also includes a steering mechanism or control system 13. The vehicle is configured to include an airbag system for providing additional protection.

The airbag system may include a front airbag 2 located at the front portion 11 of the watercraft 1, a side airbag 3 positioned along a side 10 of the watercraft 1, and a driver airbag 8 positioned on the steering control 13 to protect the driver in the event of a collision. As is well known, an airbag is typically inflated by inflation gas provided by a gas generator or inflator. Accordingly, the system may also include an inflation system for inflating the airbags. Each airbag may be provided with its own inflator or gas generator. Alternatively, the inflation gas for multiple airbags may be provided from a single gas generator.

The side airbag 3 is configured to prevent or reduce the damage resulting from a vehicle or other object from contacting the side portion 10 of the watercraft 1. The system may be configured so that both sides of the watercraft include airbags 3. The side airbags may also deploy into a position that provide protection to a swimmer or other object located in the water.

The front airbag 2 deploys into a position that would provide protection for a swimmer or other person or object from a direct contact with the watercraft 1. The front airbag may be configured as a typical driver side airbag which deploys between the driver and the steering control.

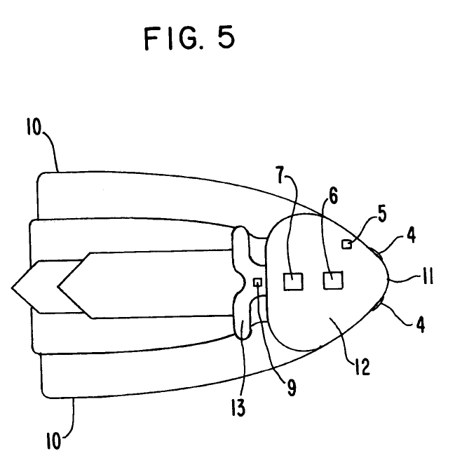

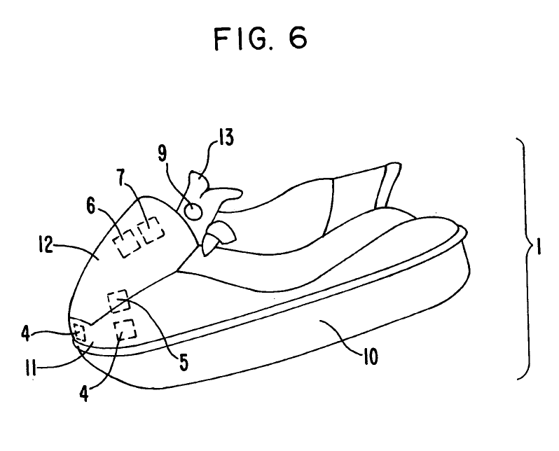

FIGS. 5 and 6 depict a typical watercraft vehicle 1 before deployment of the airbags. According to an embodiment of the present invention, the airbag system may include a proximity sensor 4 located at the front 11 of the watercraft 1. The proximity sensor 4 detects the distance from the watercraft 1 to another object, such as a swimmer or a boat. The airbag system of this embodiment may also include an acceleration sensor 5 located on the top portion 12 of the watercraft 1. The acceleration sensor 5 detects the speed of a proximate object.

The airbag system may include additional sensors such as, for example, occupant detection sensors for determining whether an occupant is seated on the saddle-type seat. Furthermore, sensors may also be provided to determine with the occupant is in a normal position or out of position (OOP). These sensors may include, seat weight sensors, infra red sensors, or ultrasonic sensors, for example. These sensors may be useful to determine whether an accident has caused the occupant to thrown from the seat, for example. In such an instance, the airbags may be selectively deployed to help stabilize the vehicle while the driver regains control and returns to the seat, for example.

According to another embodiment, the airbag system may include an employment control unit (ECU) 6 for controlling the deployment of each of the airbags. The ECU 6 may be a microprocessor based controller that receives input from various sensors and sends control or triggering signals to one or more of the airbags in the system.

The ECU is preferably located on the top portion 12 of the watercraft 1. The ECU 6 controls the deployment status of each airbag on the watercraft 1. The ECU 6 may utilizes output from the proximity sensor 4 and the acceleration sensor 5 to determine whether to deploy an airbag. Furthermore, the ECU 6 may receive input from one of the occupant sensors to determine whether an occupant is located in the seat.

The airbag system may also includes a manual deployment switch 9. The switch 9 is preferably positioned on the steering control 13 area of the vehicle. The manual deployment switch 9 allows the driver to deploy the airbags. The driver may manually deploy the airbags when necessary. This feature may be particularly useful, when the watercraft 1 is drifting at sea or lake or other body of water.

The airbags of the present invention may be made from a material having a color that contrasts from the typical surroundings of the vehicle in order to aid in locating the watercraft in case of emergency. For example, for vehicles typically operated in water, the airbags may be bright orange in order to contrast with the surrounding water and aid in locating the vehicle from air, land or sea.

According to a further embodiment of the present invention, the airbag system may include a mayday system 7. The mayday system 7 may utilize a geographic positioning system (GPS) in order to identify the location of the vehicle. In the case of emergency, the mayday system 7 may activate and broadcast the vehicle's location on predetermined emergency channels. The mayday system 7 may be configured to broadcast automatically when the airbag system is deployed in the case of emergency. The ECU 6 may be configured to initiate the mayday system 7 based on sensor input to the ECU 6 according to a predetermined criteria. According to another embodiment, the mayday 7 system may be activated by the vehicle operator by use of manual switch, such as the manual switch 9 described above.

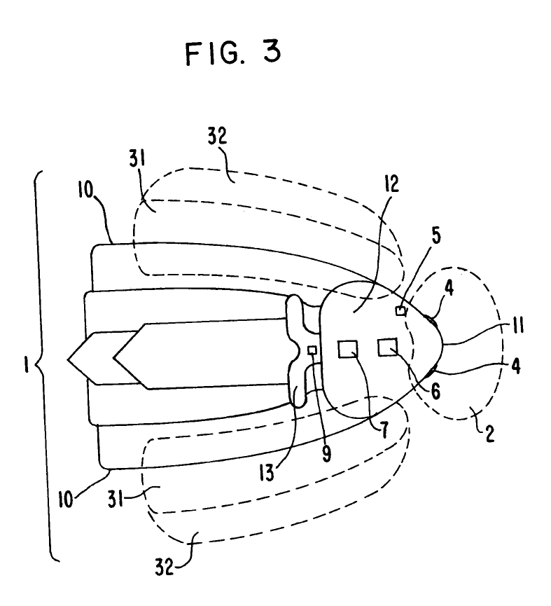

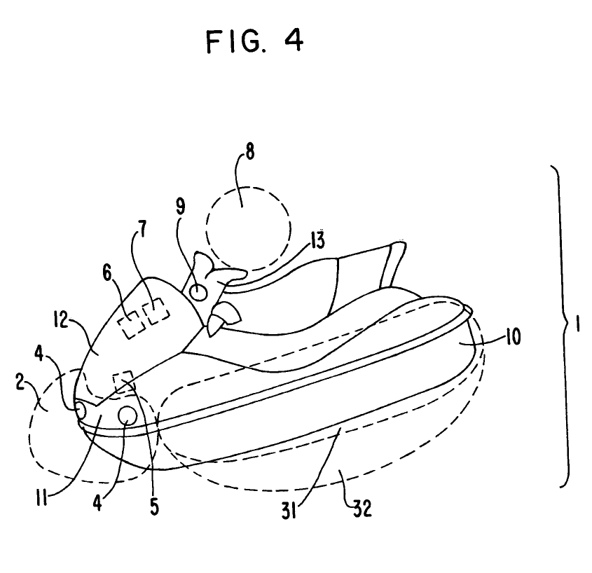

As shown in the embodiments depicted in FIGS. 3 and 4, the airbag system may include first and second level side airbags 31, 32. The first and second level side airbags 31, 32 may be independent of each other and, thus, may deploy separately as controlled by the ECU 6.

The second level side airbag 32 is configured to inflate in a direction farther away from the side 10 of the watercraft 1 than the first level side airbag 31. The second level side airbag 32 may be larger than the first level side airbag 31. The first 31 and second level 32 side airbags may be on both sides 10 of the watercraft 1.

The airbag system of this embodiment may deploy either only the first level side airbag 31 or also the second level side airbag 32. The ECU 6 utilizes output from the various sensors including, for example, the proximity sensor 4 and acceleration sensor 5 to determine whether a side airbag should be deployed. Then the ECU 6 determines whether one or both levels are required to be inflated.

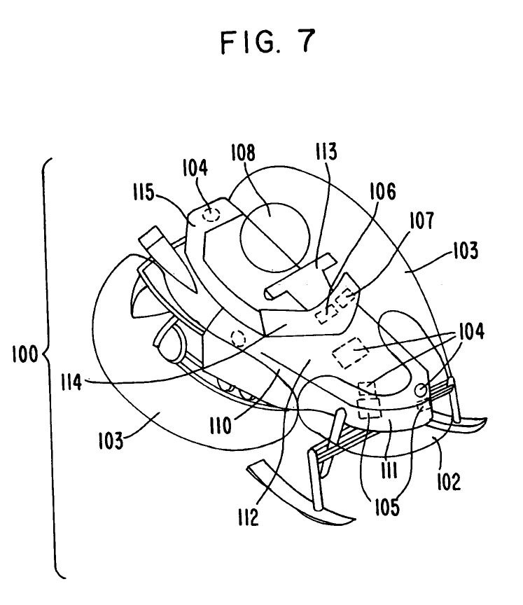

The watercraft 1, described above, is merely exemplary of a saddle seat type vehicle that may be provided with the airbag system of the present invention. FIGS. 7, 8 and 9 depict another alternative embodiment of the present invention, in which the airbag system is configured for a snowmobile 100. The features and functions of the airbag system described above may be also be used with other saddle seat type vehicles, including the snowmobile 100 described further below.

As shown in FIG. 7, the snowmobile vehicle 100 includes a side portion 110, a front portion 111, a top portion 112, a steering support 114, a steering control 113, and a rear seat portion 115. The airbag system may include a front airbag 102 positioned on the front portion 111 of the snowmobile 100, a side airbag 103 positioned along the side portion 110 of the snowmobile 100, and a driver airbag 108 positioned on the steering control 113. The front airbag 102 may protect a person, such as a skier, or an object, from any damage or injury resulting from direct contact with the snowmobile 100. Similarly, the side airbag 103 is configured to protect against both the vehicle and the colliding object or person from damage resulting from a collision with the vehicle. Side airbags 103 may be on both sides 110 of the snowmobile 100. The driver airbag 108 may be configured to deploy between the steering control 113 and the driver.

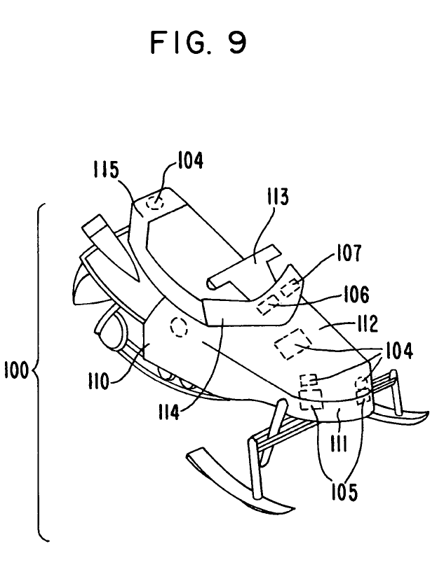

FIG. 9 shows the snowmobile 100 prior to deployment of the airbags. The airbag system of this embodiment includes an acceleration sensor 105 located on the front 111 of the snowmobile 100. The acceleration sensor 105 detects the speed of an oncoming object, skier, or snow slide. A snow slide sensor 104 is positioned on the top portion 112 of the snowmobile 100 and on the rear seat portion 115. The snow slide sensor 104 detects a snow slide through the use of, for example, a proximity sensor, object sensor, CCD camera or the like.

The airbag system according to the embodiment shown in FIGS. 7-9 may also include an ECU 106. The ECU 106 is positioned on the steering support 114. The ECU 106 may utilizes output from the snow slide sensor 104 and acceleration sensor 105 to determine whether an airbag should be deployed and which airbag should be deployed. The ECU 106 controls the status of each airbag deployment. As described above, the ECU 106 may receive input from other sensors including, for example, occupant detection sensors.

The airbag system may also include a mayday system 107 for sending signals to help locate the snowmobile 100. The mayday system may be preferably positioned on the steering support 114. The mayday system 107 may include a GPS to provide vehicle location information to be included in a broadcast signal after the airbags are deployed.

As described above, the airbags of the present invention may be of a contrasting color to aid in the finding of the snowmobile 100. The airbags may be of contrasting color to snow to help others locate the snowmobile 100, especially in the event of a snow slide.

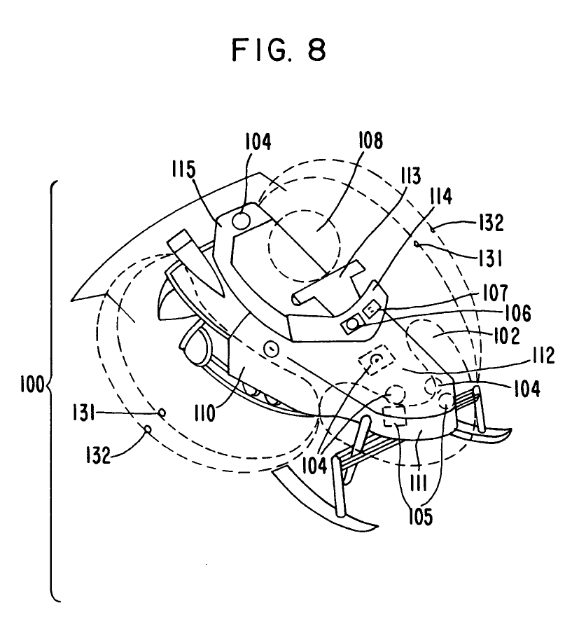

As shown in FIG. 8, the airbag system of this embodiment may include first and second level side airbags 131, 132. The first level side airbag 131 and the second level side airbag 132 may be independent of each other and, for example, may be configured to be deployed or inflated separately. The second level side airbag 132 is configured to inflate in a direction farther away from the side 110 of the snowmobile 100 than the first level side airbag 131. The first 131 and second level 132 side airbags may be on both sides 110 of the snowmobile 100.

The airbag system of this embodiment may deploy either only the first level side airbag 131 or only the second level side airbag 132, or both. The ECU 106 utilizes output from the snow slide sensor 104 and acceleration sensor 105 to determine whether the airbag should first deploy, and then determines which level, either the first 131 or second 132, the side airbag should inflate.

The second level side airbag 132 may be a larger side airbag. The second level side airbag 132 may be deployed during a snow slide to allow the snowmobile 100 to rise to the top of the sliding snow and accordingly, “float” or ride relatively safely on the top surface of a dangerous snow slide. The snowmobile 100 basically floats or slides on the deployed second level side airbag 132.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag system for a vehicle having a saddle type seat and a steering mechanism comprising:
a front airbag configured to deploy in front of the vehicle;
a first side airbag configured to deploy along a side of the vehicle; and
a driver airbag configured to deploy between a driver of the vehicle and the steering mechanism.

2. The airbag system of claim 1, further comprising a second side airbag positioned to configured to deploy along an opposite of the vehicle from the first side airbag.

3. The airbag system of claim 1, wherein the first side airbag includes a pair of airbags configured to deploy at first and second levels.

4. The airbag system of claim 3, wherein each of the pair of airbags is independent of the other one of the pair of airbags.

5. The airbag system of claim 3, wherein the second level is located along the side of the vehicle at a position that enables the vehicle to float.

6. The airbag system of claim 3, configured to be positioned on a snowmobile and including a detector for detecting an approaching snow slide.

7. The airbag system of claim 6, further comprising an acceleration sensor for detecting the speed of a proximate object.

8. The airbag system of claim 6, further comprising a control unit that controls the deployment of each airbag; and wherein the control unit is configured to utilize an output from the detector to determine whether to inflate a first or second level of the side airbag.

9. The airbag system of claim 7, further comprising a control unit that controls the deployment of each airbag; and wherein the control unit is configured to utilize an output from the sensor to determine whether to inflate a first or second level of the side airbag.

10. The airbag system of claim 1, further comprising a proximity sensor for detecting between the vehicle and an object.

11. The airbag system of claim 10, further comprising a control unit that controls the deployment of each airbag; and wherein the control unit is configured to utilize an output from the sensor to determine whether to inflate a first or second level of the side airbag.

12. The airbag system of claim 1, further comprising a mayday system for sending a locator signal.

13. The airbag system of claim 12 wherein the mayday system activates upon deployment of an airbag.

14. The airbag system of claim 1 wherein the front airbag, the driver airbag and the side airbag are formed from a material having a color that contrasts with a color of the saddle vehicle and water.

15. The airbag system of claim 1, wherein the side airbag is a color contrasted to a color of the saddle vehicle and water.

16. The airbag system of claim 1, wherein the front airbag, driver airbag, and first side airbag are formed from a material having a color that contrasts with a color of the saddle vehicle and snow.

17. The airbag system of claim 3, wherein the second level side airbag is a color contrasted to the color of the vehicle and snow.

18. The airbag system of claim 1, further comprising a manually operated switch for controlling the deployment of one of the airbags.

19. An airbag system for a vehicle having a saddle seat, wherein the airbag system is configured to detect a proximate object and deploy at least one of a plurality of airbags to protect the vehicle and/or the object from damage resulting from a collision between the object and the vehicle.

20. An airbag system for a snowmobile, wherein the airbag system includes an airbag that is configured to inflate in the event of a snow slide to protect the snowmobile and its driver.

21. An airbag system for a snowmobile, the system including a plurality of airbags configured to inflate around the exterior of the snowmobile when a collision between the snowmobile and an object is detected to thereby protect the snowmobile and the object from injury or damage.

22. An airbag system for a water craft having a saddle type seat for an operator of the craft, wherein the system includes a plurality of inflatable bags that are configured to inflate when a controller determines that the craft is in imminent danger of a collision or sinking.
